(19) United States
(12) Patent Application Publication
(10) Pub. No.: US 2014/0026104 A1
(43) Pub. Date: Jan. 23, 2014

(54) DISPLAY CONTROL DEVICE, DISPLAY CONTROL METHOD, AND PROGRAM

(71) Applicant: CANON KABUSHIKI KAISHA, Tokyo (JP)

(72) Inventor: Ken Tokita, Kawasaki-shi (JP)

(21) Appl. No.: 13/940,323

(22) Filed: Jul. 12, 2013

(30) Foreign Application Priority Data
Jul. 17, 2012 (JP) 2012-158701

(51) Int. Cl. G06F 3/0481

(52) U.S. Cl. CPC G06F 3/04817
USPC 715/854

(57) ABSTRACT

To make it easy for a user to find a target folder. A jump icon relating to a specific folder is displayed on a scroll bar lane. In the case where a jump icon is selected by a user's click operation, a file associated with a specific folder is displayed.

### BACKGROUND OF THE INVENTION

1. Field of the Invention

The present invention relates to a display control device, a display control method, and a program for performing display control in order to easily find a file stored in a storage device.

2. Description of the Related Art

There is a document management system in which a device operated by a user can access a storage device storing various kinds of information in units of folders in a hierarchy to browse the state of the hierarchy or to utilize information associated with the hierarchy.

In the case where a user searches for a specific folder by displaying a hierarchy in a tree structure on a terminal operated by the user, it is common to search by sequentially selecting the level of the hierarchy in a descending order from a top-level folder to lower-level folders on the tree.

However, for a tree including a large number of folders or levels of the hierarchy, there is a case where it is not possible to display the entire tree in a predetermined display region. Consequently, in such a tree, part of the tree is displayed in the display region and a user changes the displayed part of the tree by manipulation to search for a target folder.

In Japanese Patent Laid-Open No. H05-189177 (1993), in order to efficiently perform search, change and etc. of a folder on the tree in the case where the tree is displayed partially as described above, a scale mark is attached to a scroll bar for each folder of the tree so that a corresponding folder is reached by clicking the scale mark.

The technique described in Patent Document 1 has such a problem that the scale marks are attached only to lower-level folders of the top-level folder and in the case where the number of lower-level folders is large, the width of the scale mark becomes narrower, and therefore, the scale mark becomes hard to see and manipulate. Furthermore, there is also such a problem that the scale mark is attached also to a folder that a user seldom utilizes, and therefore, it is not possible to instantaneously determine which scale mark indicates a folder the user frequently utilizes.

### SUMMARY OF THE INVENTION

The display control device according to the present invention is characterized by including a tree display unit configured to display folders managed hierarchically in a storage device in a tree structure, a reception unit configured to receive a specification of a folder to be displayed as a jump icon from a user, and an icon display unit configured to display a jump icon for displaying the specified folder on a scroll bar lane.

According to the present invention, it is made easier for a user to search for a target folder or a file associated with a target folder, and therefore, it is possible to improve convenience of the user.

Further features of the present invention will become apparent from the following description of exemplary embodiments (with reference to the attached drawings).

### BRIEF DESCRIPTION OF THE DRAWINGS

FIG. 1 is a diagram showing a configuration of a system according to Example 1;

FIG. 2 is a diagram showing a configuration of a document management server device according to the Example 1;

FIG. 3 is a diagram showing a function configuration of the document management server device according to the Example 1;

FIG. 4 is a diagram showing a configuration of a client device according to the Example 1;

FIG. 5 is a diagram showing a function configuration of the client device according to the Example 1;

FIG. 6 is a diagram showing an example of a document management screen according to the Example 1;

FIG. 7 is a diagram for explaining the way a jump icon according to the Example 1 is set;

FIG. 8 is a diagram showing an example of a jump icon save setting dialog according to the Example 1;

FIG. 9 is a diagram showing the way the jump icon according to the Example 1 is displayed;

FIG. 10 is a diagram for explaining display control after the jump icon is selected according to the Example 1;

FIG. 11 is a diagram for explaining the display control after the jump icon is selected according to the Example 1;

FIG. 12 is a diagram for explaining display processing in a case where the jump icon is moused over according to the Example 1;

FIG. 13 is a diagram showing the way a path is displayed with a tool tip according to the Example 1;

FIG. 14 is a flowchart showing a processing procedure of processing to set the jump icon according to the Example 1;

FIGS. 15A and 15B are flowcharts showing a processing procedure of processing to display the jump icon and a path tree according to the Example 1;

FIG. 16 is a flowchart showing a processing procedure of processing to display folder contents according to the Example 1;

FIG. 17 is a diagram for explaining a merge jump icon according to Example 2;

FIG. 18 is a flowchart showing a processing procedure of merge jump icon merge processing according to the Example 2; and

FIG. 19 is a flowchart showing a processing procedure of display control processing for various kinds of manipulation for the merge jump icon according to the Example 2.

### DESCRIPTION OF THE EMBODIMENTS

Hereinafter, aspects for embodying the present invention are explained using the drawings.

### Example 1

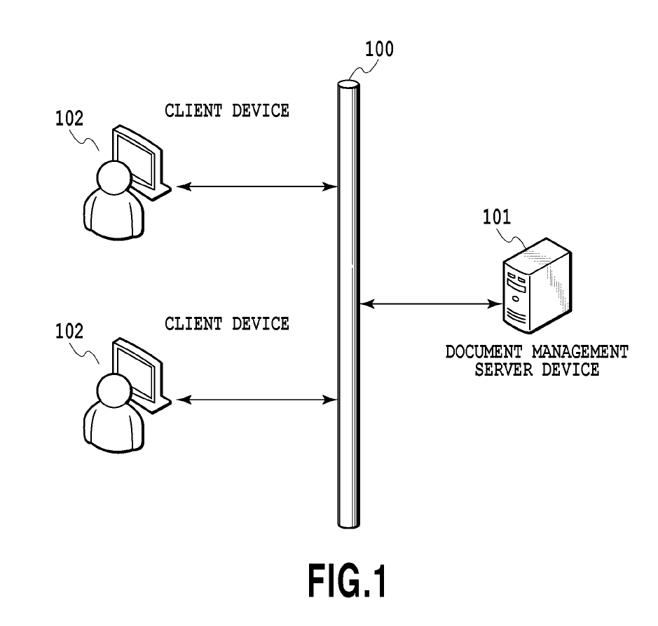

A first embodiment of the present invention will be explained using FIG. 1 to FIG. 16.

### [System Configuration]

FIG. 1 is a diagram showing a configuration of an entire system according to the embodiment of the present invention. The system includes a document management server device 101, a client device 102, and a network 100.

The document management server device 101 hierarchically manages various kinds of file, such as document information, and provides a file in response to a request from the client device 102.

The client device 102 can give various kinds of instructions to the document management server device 101 and functions as an interface configured to enable a user to display and manipulate document information. As shown in FIG. 1, the number of the client devices 102 is not limited to one but may be plural.

The network 100 may be, for example, any medium that enables communication between the client device 102 and the document management server device 101, such as the Internet. For example, the network 100 may be a network system, such as a Local Area Network (hereinafter, LAN). In the present example, a case is explained where as the network 100, the Internet is utilized.

### [Hardware Configuration of Document Management Server Device]

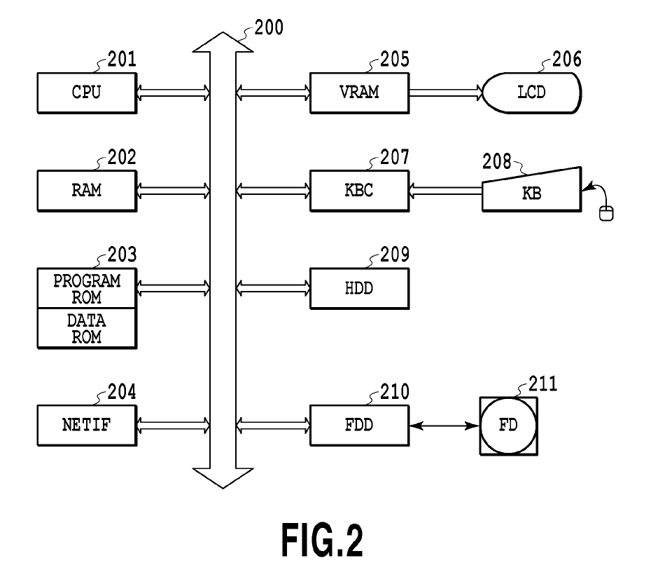

FIG. 2 is a diagram showing an example of a hardware configuration of the document management server device 101 according to the embodiment of the present invention.

A CPU 201 is a central processing unit configured to control the whole of the document management server device by performing calculation and control in accordance with programs.

A RAM 202, which is a random access memory, functions as a main memory of the CPU 201. Further, the RAM 202 functions as a storage region of programs, an execution area of the programs, and a data area of the programs.

A ROM 203, which is a read-only memory, stores operation processing procedures of the CPU 201. Further, the ROM 203 includes a program ROM recording the basic software (OS), which is the system program to perform equipment control of the information processing device and a data ROM in which information etc. necessary to run the system is recorded. There is a case where an HDD 209 is used in place of the ROM 203. The CPU 201 executes the programs stored in the program ROM 203, and thereby various kinds of processing, to be described later, are realized.

A NETIF 204, which is a network interface, performs control to perform data transfer with an external device via the network 100, diagnosis of the connection situation of its own device to the network 100, etc. A VRAM 205, which is a video RAM, develops an image to be displayed on a screen of an LCD 206 and performs display control of the image.

The LCD 206 is display etc. to display the operating state etc. of the information processing device on a screen.

A KBC 207 is a keyboard controller configured to control an input signal from a KB 208, which is a keyboard. The KB 208 is an input device that receives various kinds of manipulation performed by a user, and for example, a pointing device, such as a keyboard and mouse, is used as the KB 208.

The HDD 209 is a hard disk drive to store application programs and various kinds of data. The application programs in the present example are software programs etc. to control various kinds of processing unit.

An FDD 210 is a magnetic recording medium, such as a flexible disk drive. An optical recording medium, such as a CD-ROM drive, a removable disc, such as a magneto-optical recording medium, such as an MO, and a semiconductor recording medium, such as a memory card, may also be used. For example, the FDD 210 is used to read the application programs etc. described previously from the recording medium.

An FD 211 is a removable data recording medium configured to save data read by the FDD 210, and is, for example, a floppy disc. Further, an optical recoding medium (for example, a CD-ROM), a magneto-optical recording medium (for example, an MO), and a semiconductor recording medium (for example, a memory card) may also be used. It is also possible for the FDD 210 to read and use the application programs and data stored in the HDD 209 from the FD 211.

### [Configuration of Document Management Server Device]

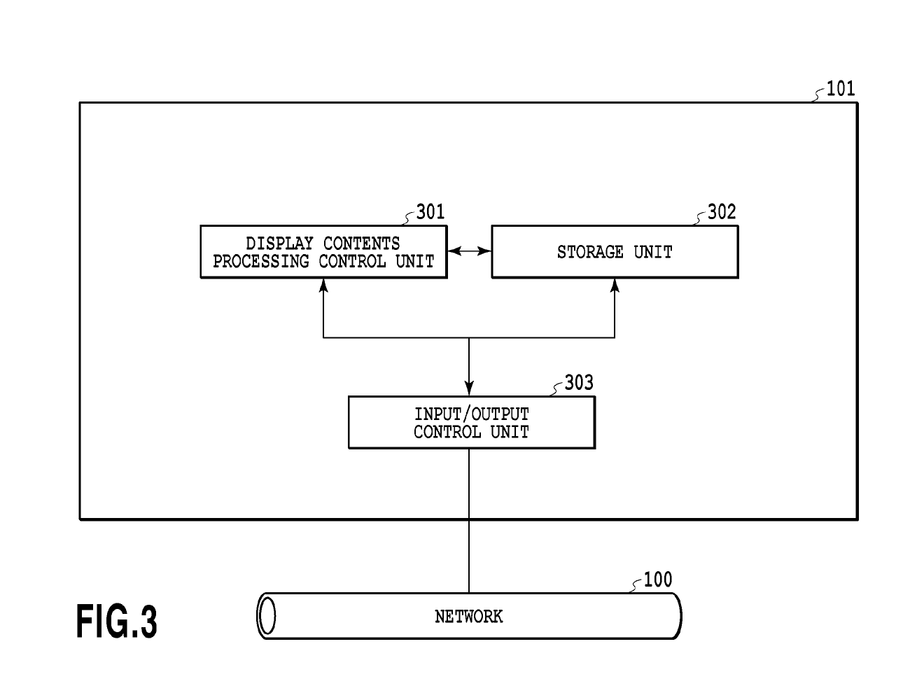

FIG. 3 is a function block diagram showing a configuration of a document management server device according to the example of the present invention.

The document management server device 101 includes a display contents processing control unit 301, a storage unit 302, and an input/output control unit 303.

The display contents processing control unit 301 performs processing to transmit a processing result by another component to the client device 102.

The storage unit 302 includes a storage device, such as the HDD 209, and stores document information and input/output information.

The input/output control unit 303 controls the transmission of information to the client device 102 and the reception of information from the client device 102.

### [Hardware Configuration of Client Device]

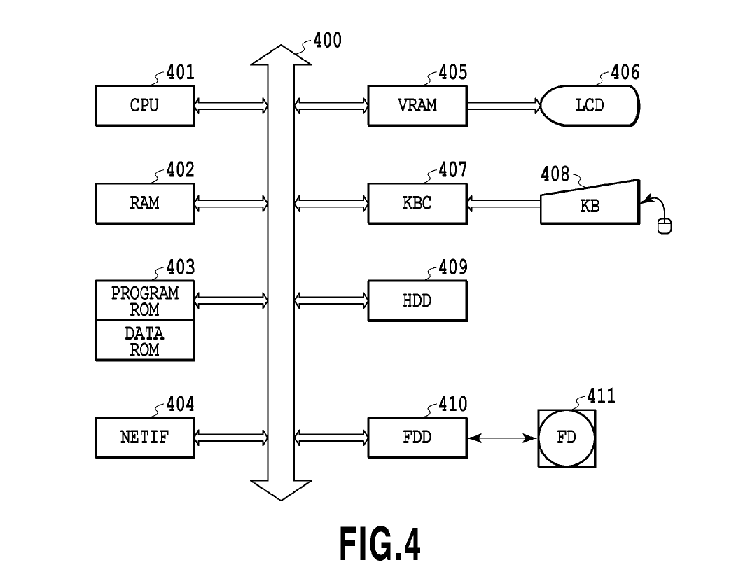

FIG. 4 is a diagram showing a hardware configuration of the client device according to the embodiment of the present invention.

A CPU 401 is a central processing unit configured to control the whole of the client device by performing calculation and control in accordance with programs.

A RAM 402 is a random access memory that functions as a main memory of the CPU 401. Further, the RAM 402 functions as a storage region of programs, an execution area of the programs, and a data area of the programs.

A ROM 403 is a read-only storage medium configured to store operation processing procedures of the CPU 401. The ROM 403 includes a program ROM recording the basic software (OS), which is the system program to perform equipment control of the client device, and a data ROM in which information etc. necessary to run the system is recorded. It may also be possible to use an HDD 409 in place of the ROM 403.

A NETIF 404 is a network interface configured to perform control to perform data transfer with an external device via a network 400, diagnosis of the connection situation of its own device to the network 100, etc.

A VRAM 405 is a video RAM to develop an image to be displayed on a screen of an LCD 406 and to perform control of a display of the image.

The LCD 406 is a display device, such as a display, to display the operating state of the client device etc.

A KBC 407 is a keyboard controller to control an input signal from a KB 408.

The KB 408 is an input device to receive various kinds of manipulation performed by a user and is, for example, a keyboard. Moreover, a pointing device, such as a mouse, is also used as the KB 408.

The HDD 409 is a hard disk drive to save application programs, various kinds of data, etc. Note that, the application programs are software programs etc. to cause various kinds of processing unit to operate.

An FDD 410 reads data from and writes data to a magnetic recording medium, such as a flexible disk drive. An optical recording medium, such as a CD-ROM drive, a removable disc, such as a magneto-optical recording medium, such as an MO, and an external input device that inputs and outputs data of a semiconductor recording medium, such as a memory card, may also be used. For example, the FDD 410 is used to read the application programs etc. described previously from the recording medium.

An FD 411 is a removable medium of a removable data recording medium that saves data read by the FDD 410. The FD 411 is, for example, a magnetic recording medium (for example, a flexible disc). An optical recording medium (for example, a CD-ROM), a magneto-optical recording medium (for example, an MO), and a semiconductor recording medium (for example, a memory card) may also be used.

It is also possible for the FDD 410 to read and use the application programs and data stored in the HDD 409 from the FD 411.

### [Configuration of Client Device]

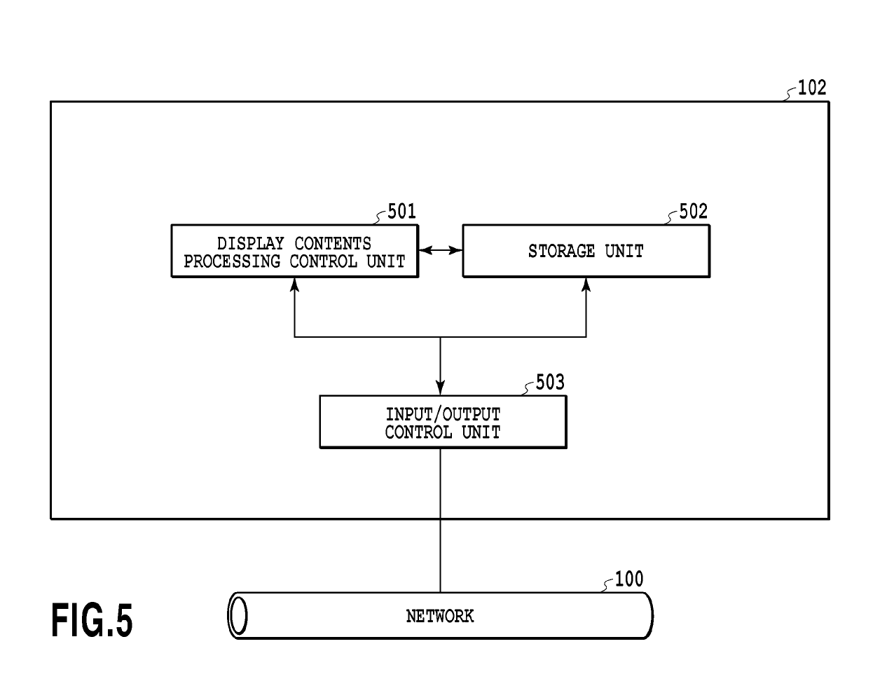

FIG. 5 is a function block diagram showing a configuration of the client device according to the embodiment of the present invention.

The client device 102 includes a display contents processing control unit 501, a storage unit 502, and an input/output control unit 503.

The display contents processing control unit 501 generates an image based on information transmitted from the document management server device 101 and causes the LCD 406 to display the image. Further, the display contents processing control unit 501 performs processing and control to transmit information input from the KB 408 to the document management server device 101.

The storage unit 502 includes a storage device, such as the HDD 409, and stores document information and input/output information.

The input/output control unit 503 controls the input by a user, the transmission to the document management server device, and the reception from the document management server device.

### [Details of Jump Icon]

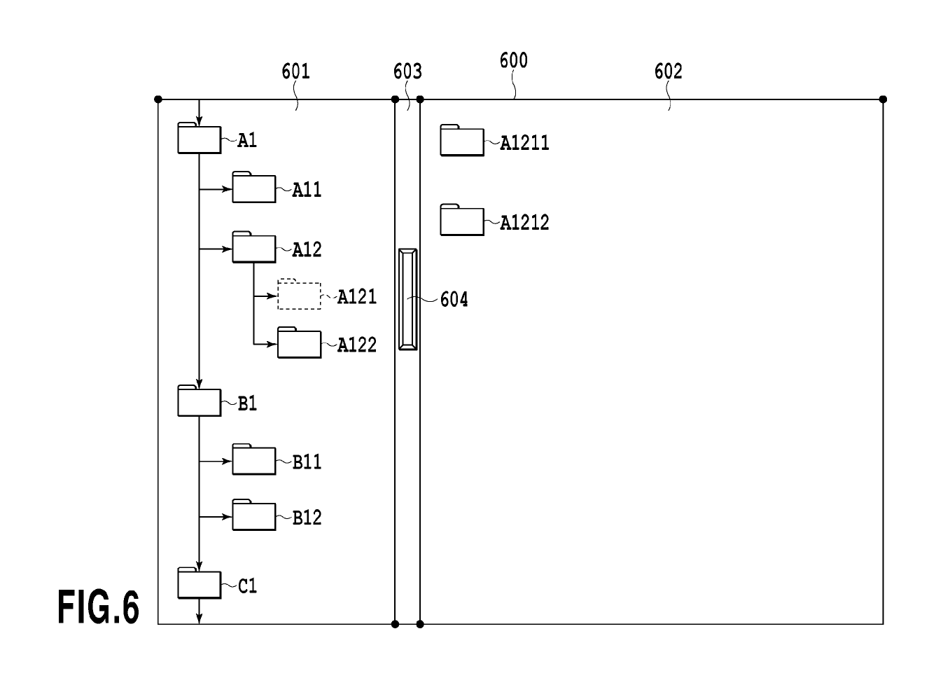

Hereinafter, processing relating to a jump icon, which features the present invention, is explained using FIG. 6 to FIG. 9. The jump icon is an icon associated with a specific folder and is displayed on a scroll bar. In the present example, an example is explained in which the jump icon is displayed on the scroll bar, but this is not limited.

FIG. 6 is an example of the document management screen displayed on the LCD 406 in the case where a user accesses (logs in to) the document management server device 101 via the client device 102.

A document management screen 600 includes a folder tree display region 601 and a document display region 602.

In the document management server device 101, information is stored in a hierarchical structure in units of folders and the folder tree display region 601 is a display region in which the hierarchy is displayed as a tree so as to be easily understood visually. The document display region 602 displays, in the case where a folder in the folder tree displayed in the folder tree display region 601 is specified, lower-level folders or files relating to the specified folder.

The document management screen is not limited to the document management screen 600 shown in FIG. 6.

Because of a limitation on the size of the display region, there is a case where the folder tree display region 601 cannot display all the folders at the same level in the hierarchy of the folder tree at a time. In the document management screen 600, folders A1 to C1 have the relationship of the same level in the hierarchy on the tree.

Here, in the case where there exists another folder at the same level in the hierarchy as that of the folders A1 to C1, the folder is not displayed in the folder tree display region 601 in FIG. 6. In such a case, a scroll bar lane 603 and a scroll bar knob 604 are displayed.

The scroll bar lane 603 has a length corresponding to the length of the entire folder tree and the upper end and the lower end of the scroll bar knob 604 correspond to the upper end the and lower end of the folder tree display region 601, respectively. Therefore, by moving the scroll bar knob 604 vertically by the screen manipulation of a user, it is possible to display the folder, which has not been displayed in the folder tree display region 601, in the folder tree display region 601.

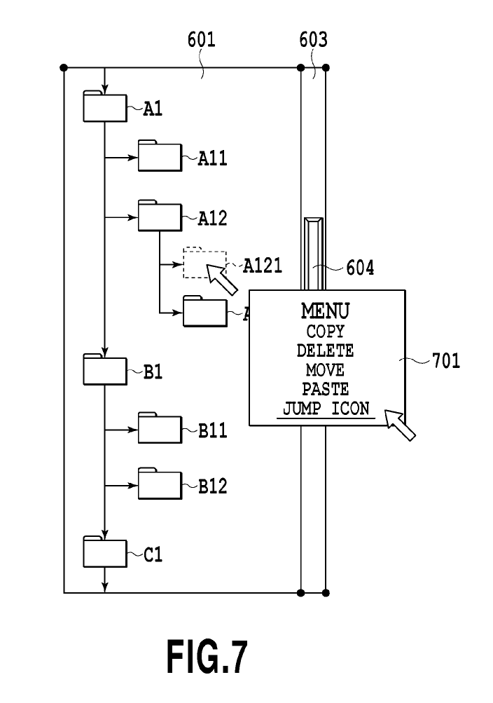

FIG. 7 is a diagram for explaining the way a jump icon is set to a specific folder from among the folders displayed in the folder tree display region 601.

First, a user moves a cursor (in the shape of an arrow shown in FIG. 7) onto the folder A121 to select a folder A121, and thus a menu 701 is displayed.

Next, the user selects an item of jump icon from among a plurality of items in the menu 701. Thereby, the jump icon is set to the folder A121.

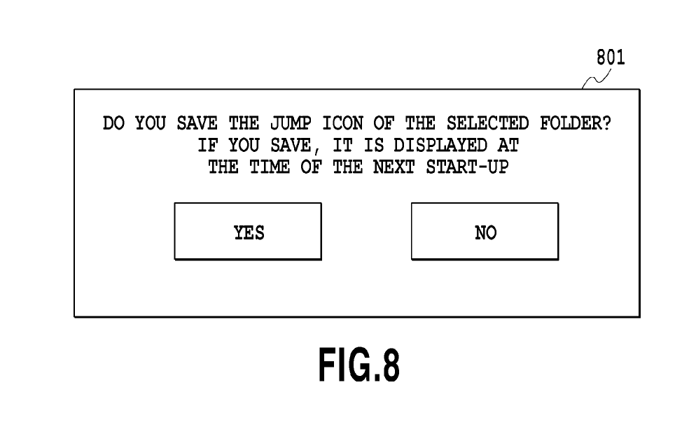

FIG. 8 is a diagram showing an example of a jump icon save setting dialog, which is displayed after the jump icon is set via the menu 701.

In the case where an item “YES” displayed in a jump icon save setting dialog 801 is selected, setting is done so that the set jump icon is displayed at the time of the next start-up. On the other hand, in the case where an item “NO” is selected, setting is done at the time of termination of the display of a client UI so that the jump icon is not displayed at the time of the next start-up. This save setting can be done for each folder because the setting can be done at the time of display and selection of the jump icon.

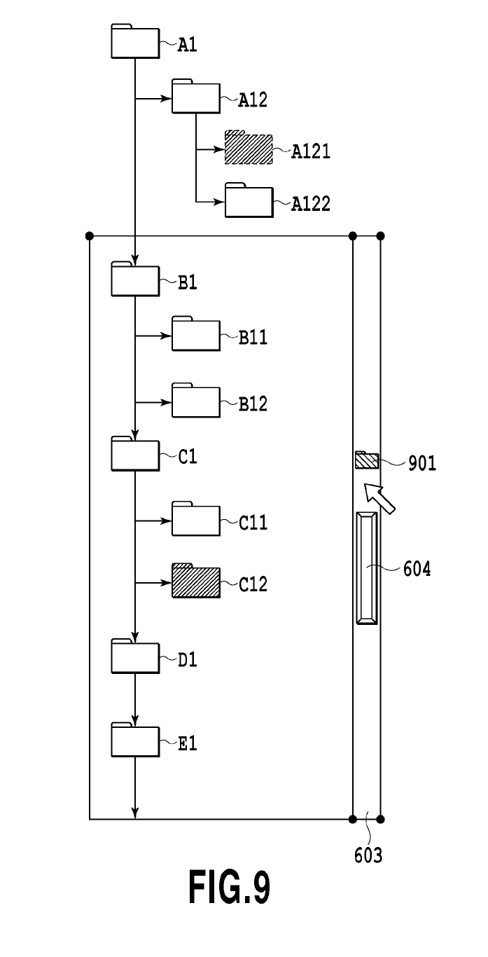

FIG. 9 is a diagram showing the way a jump icon 901 is displayed on the scroll bar lane 603 after the jump icon is set. FIG. 9 shows a state where the folder tree display region 601 is scrolled to display folders B1 to E1 after the jump icon is set to the folder A121. That is, folders A1 to A122 in FIG. 9 are displayed for explanation and are not actually displayed because they are outside the display region.

It is possible to display the jump icon 901 on the scroll bar lane 603 in correspondence to the relative position of the selected folder in the entire tree. However, the jump icon 901 is not displayed on the scroll bar knob 604. Further, the jump icon 901 is displayed only in the case where the folder A121 to which the jump icon is set is outside the display region of the folder tree display region 601.

Here, a case where the jump icon is set to the folder A121 located outside the region of the folder tree display region 601 is explained. In this case, the jump icon 901 is arranged on the scroll bar lane 603 made to correspond to the folder tree so that the position is relatively the same position of the folder A121 in the folder tree. That is, as shown in FIG. 9, the jump icon 901 set to the folder A121 is displayed in correspondence to the position of the folder A121 in the folder tree.

For example, as another example, it is supposed that the jump icon is set to a folder C12. In this case, according to the relative position relationship, the jump icon is to be displayed on the scroll bar knob 604. However, in this case, there is a possibility that recognizability and operability are reduced because the jump icon and the scroll bar knob 604 overlap. Therefore, the jump icon set to the folder C12 at this time is not displayed.

Further, the display position of the jump icon 901 on the scroll bar lane 603 also changes in accordance with the size of the entire folder tree that changes in accordance with the manipulation to display lower-level folders by developing the higher-level folder or the manipulation to hide the lower-level folders by closing the higher-level folder. That is, the size and the display position of the scroll bar knob 604 change in accordance with the size of the entire folder tree, and therefore, the jump icon is also controlled so as to be displayed in the corresponding position on the scroll bar lane 603.

Further, it is also possible to display the jump icon 901 only in the case where the cursor is on the scroll bar lane 603 and not to display it in the case where the cursor is in other positions (for example, in the document display region 602).

[Display Control in the Case where Jump Icon is Selected]

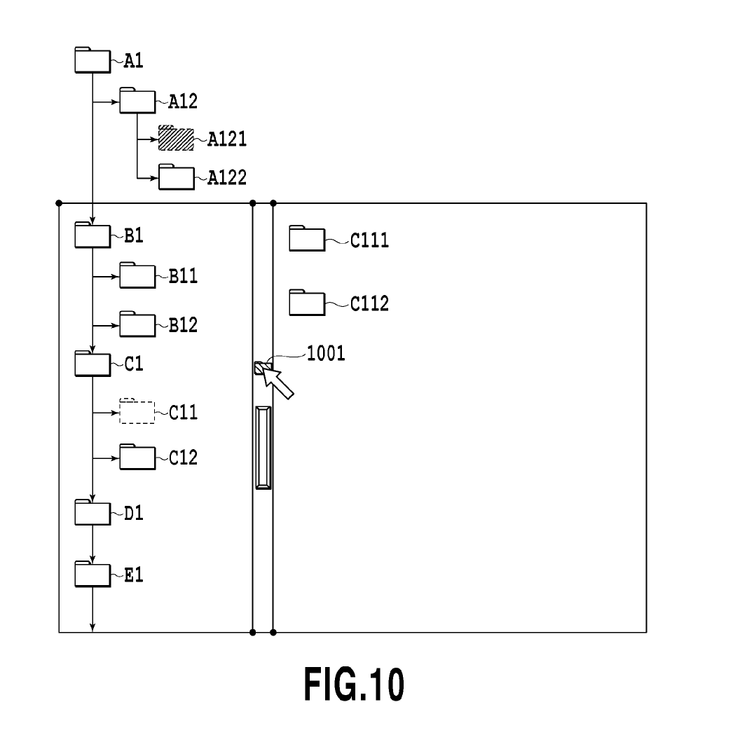

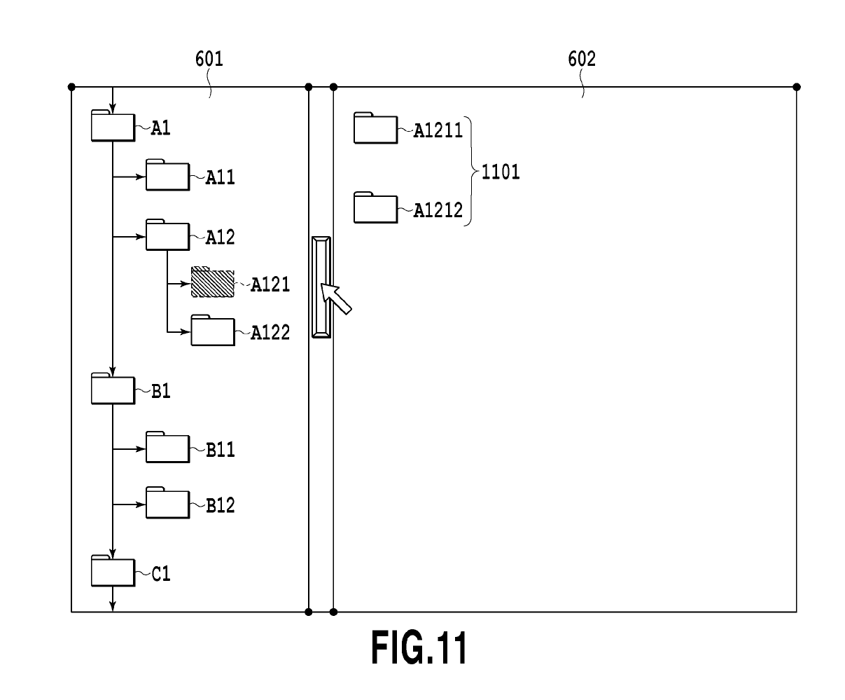

Hereinafter, using FIG. 10 and FIG. 11, display control in the case where a jump icon is clicked (selected) is explained.

FIG. 10 shows the way the jump icon is set to the folder A121 and a jump icon 1001 is displayed on the scroll bar lane. Further, in FIG. 10, lower-level folders C111 and C112 belonging to a folder C11 are displayed in the document display region 602 through the selection of the folder C11 by a user.

FIG. 11 shows an example in the case where lower-level folders belonging to the folder A121 to which the jump icon 1001 is set are displayed in the document display region 602 through clicking of the jump icon 1001 shown in FIG. 10 by a user.

In other words, in the case where a user clicks and selects the jump icon 1001 shown in FIG. 10, the document display region 602 is updated and a lower-level folder 1101 (A1211 and A1212) belonging to the folder A121 is displayed as shown in FIG. 11.

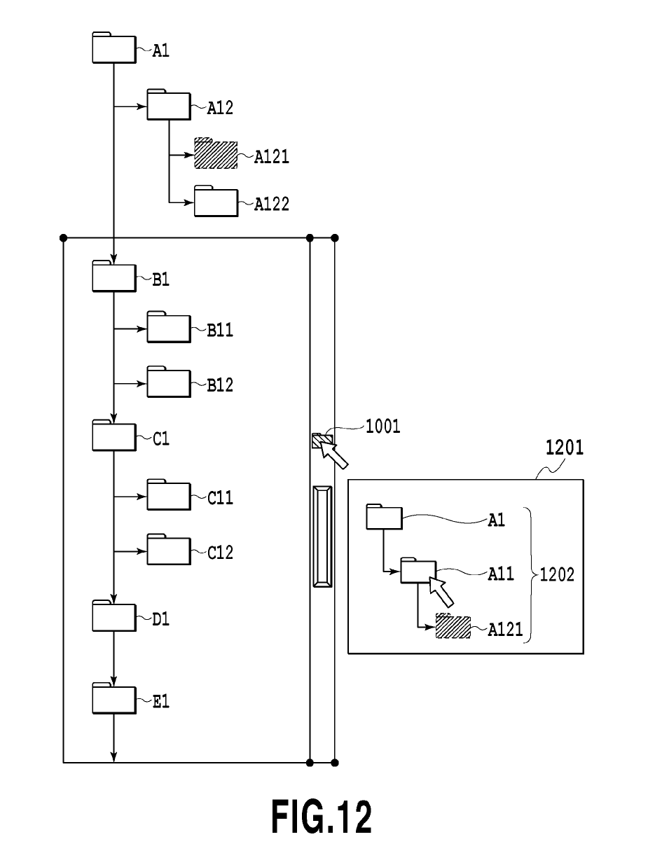

FIG. 12 shows the way the path of the folder A121 to which the jump icon 1001 is set is displayed with a tool tip in the tree form by putting the cursor on (hereinafter, to mouse over) the jump icon 1001 without clicking it.

In other words, in the case where the cursor is moused over the jump icon 1001, for a folder to which the jump icon 1001 is set, a tool tip 1201 is displayed which shows the path indicating the hierarchical relationship from the top-level to the folder in the hierarchy. Further, to each folder relating to the path displayed on the tool tip 1021, a link is set.

Consequently, a user selects and clicks any of folders 1202 included in the path, and thereby data or a folder belonging to the folder selected by the user is displayed in the document display region 602.

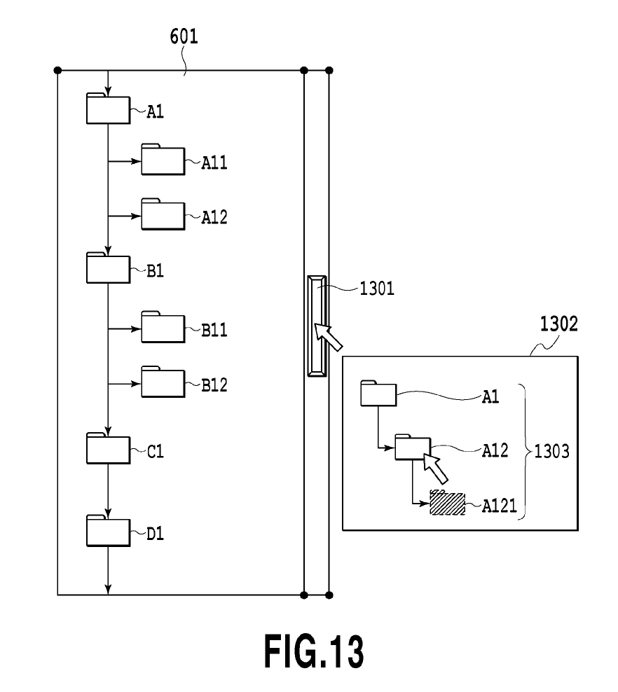

FIG. 13 is a diagram for explaining processing in the case where a folder to which the jump icon is set is not displayed in the folder tree display region 601 because the folder to which the jump icon is set is a lower-level folder in the folder hierarchy.

In this case, the folder to which the jump icon is set is the folder A121 belonging to the folder A12. In the folder tree display region 601 in FIG. 13, the folder A12 is not developed, and therefore, the folder A121 is not displayed.

Here, in the case where the user mouses over a scroll bar knob 1301, a tool tip 1302 (tool tip in which the path of the folder A121 to which the jump icon is set is displayed in the tree form) is displayed. To each of the folders A1, A12, and A121 of a tree 1303 displayed within the tool tip 1302, a link is set, respectively.

In the case where a user clicks and selects any of the folders A1, A12, and A121, data etc. associated with the selected folder is displayed in the document display region 602. Further, also in the folder tree display region 601, the display is changed in accordance with the selected folder.

Next, using a flowchart, the procedure of display setting processing of a jump icon is explained.

### <Processing Procedure of Jump Icon Setting>

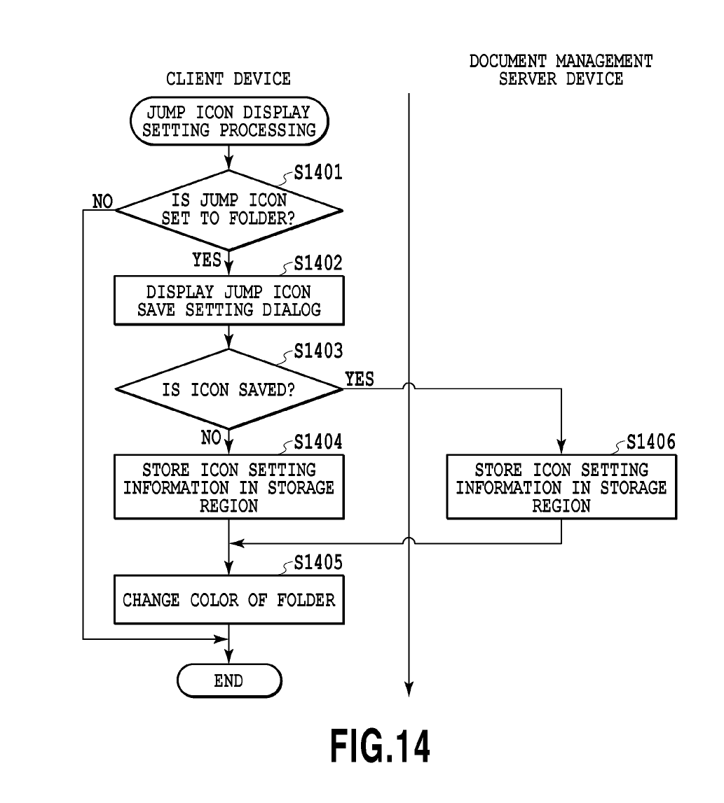

FIG. 14 is a flowchart showing a procedure of processing to save information on the setting of a jump icon explained using FIG. 7 and FIG. 8.

First, at step S1401, the display contents processing control unit 501 determines whether a user has set a jump icon to a specific folder on the folder tree. In the case where it is determined that a jump icon is set (YES at step S1401), the procedure proceeds to step S1402.

At step S1402, the display contents processing control unit 501 causes the LCD 406 to display the jump icon save setting dialog 801.

At step S1403, the display contents processing control unit 501 determines whether the user has selected to save the icon in the jump icon save setting dialog 801 (whether “YES” is selected). In the case where it is determined that “YES” is selected (YES at step S1403), the client device 102 transmits a save request to the document management server device 101 via the input/output control unit 503 and the procedure proceeds to step S1406.

Next, at step S1406, the document management server device 101 stores, in the storage unit 302, icon setting information on the folder to which the jump icon is set. This icon setting information includes at least one of a folder ID, a folder name, a path of the folder, and a lower-level folder(s)•document of the folder.

On the other hand, in the case where it is determined that the user has not selected to save the icon (the case where it is determined that “NO” is selected) at step S1403, the client device 102 stores the icon setting information in the storage unit 502 at step S1404.

At step S1405, the display contents processing control unit 501 displays the folder to which the jump icon is set on the LCD 406 after changing the color of the folder in accordance with the icon setting information. It is also possible to change the color of the folder by using “Save/delete” of the icon save setting. By changing the color of the folder, it is made easier to visually recognize the folder to which the jump icon is set on the folder tree display region 601.

### <Jump Icon Display Processing>

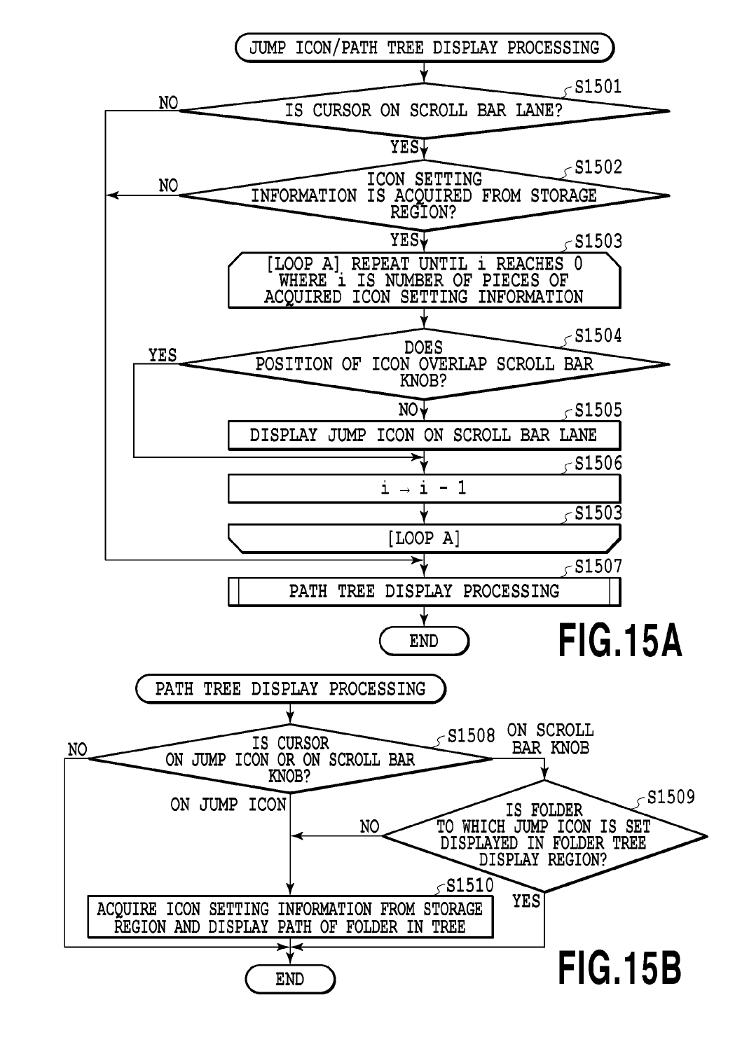

FIG. 15A is a flowchart showing a procedure of processing to display a jump icon on the scroll bar lane and processing to display the path tree of the folder explained using FIG. 9.

First, at step S1501, the display contents processing control unit 501 determines whether the cursor is on the scroll bar lane. In the case where it is determined that the cursor is on the scroll bar lane (YES at S1501), the display contents processing control unit 501 tries to acquire icon setting information that is stored.

Next, at step S1502, the display contents processing control unit 501 determines whether the icon setting information has been acquired. In the case where the icon setting information has been acquired (S1502; YES), the procedure proceeds to step S1503.

Next, at step S1503, the display contents processing control unit 501 repeats step S1504 and step S1505 until i, which is the number of pieces of acquired icon setting information, reaches zero.

At step S1504, the display contents processing control unit 501 determines whether the position where the jump icon is displayed overlaps the scroll bar knob. In the case where it is determined that the position where the jump icon is displayed does not overlap the scroll bar knob, the display contents processing control unit 501 displays the jump icon on the scroll bar lane at step S1505.

At step S1506, the display contents processing control unit 501 decrements i.

At step S1507, the display contents processing control unit 501 performs processing to display the path of the folder to which the jump icon is set with a tool tip in accordance with the position of the cursor. Detailed processing at step S1507 is explained using the flowchart of FIG. 15B.

FIG. 15B is a flowchart showing a procedure of the path tree display processing at step S1507.

First, at step S1508, the display contents processing control unit 501 determines whether the cursor is moused over on the jump icon or on the scroll bar knob. In the case where it is determined that the cursor is not moused over on the jump icon or on the scroll bar knob, this processing is exited.

In the case where it is determined that the cursor is moused over on the scroll bar knob at step S1508, the procedure proceeds to step S1509. In the case where it is determined that the cursor is moused over on the jump icon at step S1508, the procedure proceeds to step S1510.

At step S1509, the display contents processing control unit 501 determines whether the folder to which the jump icon is set is displayed in the folder tree display region 601.

In the case where it is determined that the folder to which the jump icon is set is not displayed at step S1509 (NO at S1509), the procedure proceeds to step S1510. On the other hand, in the case where it is determined that the folder to which the jump icon is set is displayed at step S1509 (YES at S1509), this processing is exited.

At step S1510, the display contents processing control unit 501 acquires the icon setting information and displays the folder path (S1510).

After the folder path is displayed, the path tree display processing is completed.

### <Folder Contents Display Processing by Clicking Jump Icon>

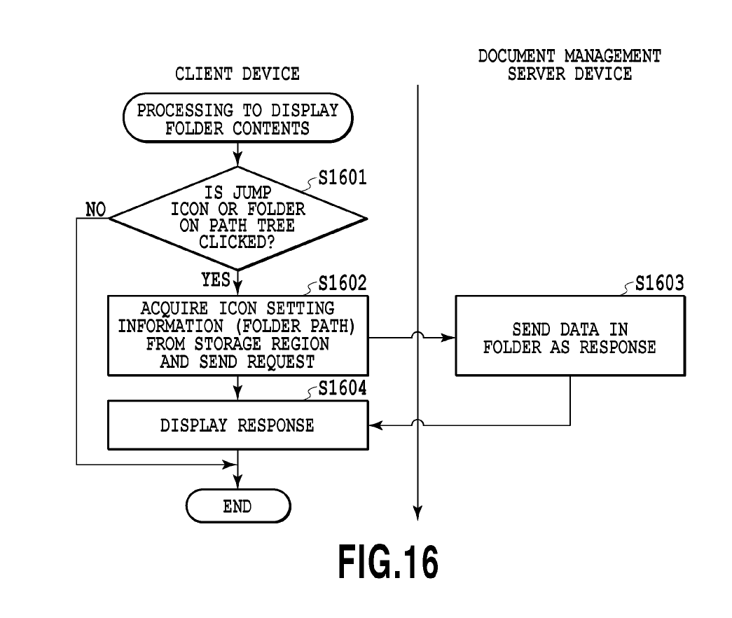

FIG. 16 is a flowchart showing a procedure of processing to display folder contents in response to the click operation of a user to the jump icon or a folder on the path tree.

First, at step S1601, the display contents processing control unit 501 of the client device 102 determines whether the jump icon or the folder relating to the path tree has been clicked. In the case where it is determined that the jump icon or the folder relating to the path tree has been clicked (YES at S1601), the procedure proceeds to step S1602. On the other hand, in the case where it is determined that the jump icon or the folder relating to the path tree has not been clicked (NO at S1601), this processing is exited.

At step S1602, the display contents processing control unit 501 acquires the icon setting information and sends a request to the document management server device 101 via the input/output control unit 503.

At step S1603, the display contents processing control unit 301 of the document management server device 101 acquires folder information from the storage unit 302 and sends a response to the client device 102.

At step S1604, the display contents processing control unit 501 displays the contents (data etc. stored in the folder) of the clicked folder based on the response (folder information) from the document management server device 101.

By the clicking of the jump icon as described above, the display in the folder tree display region 601 and the display in the document display region 602 are updated.

### Example 2

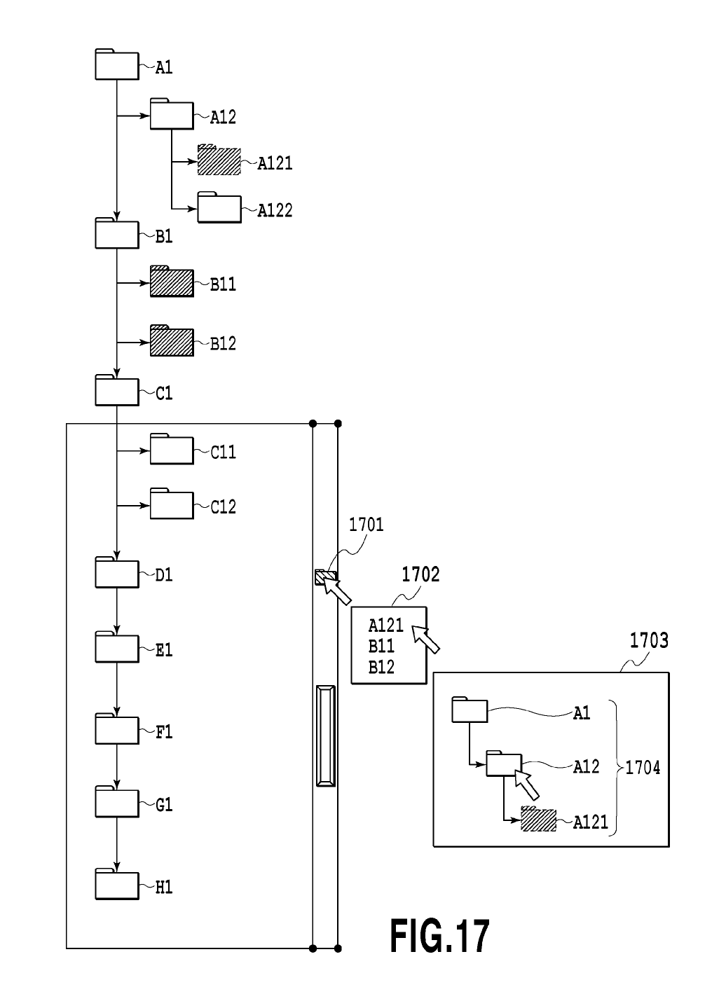

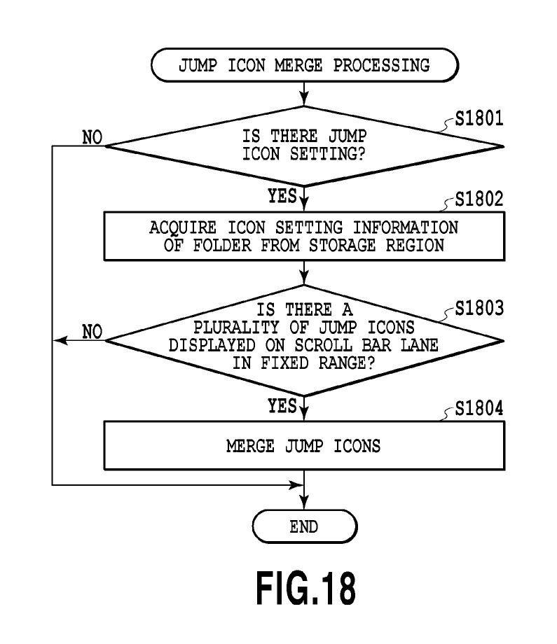

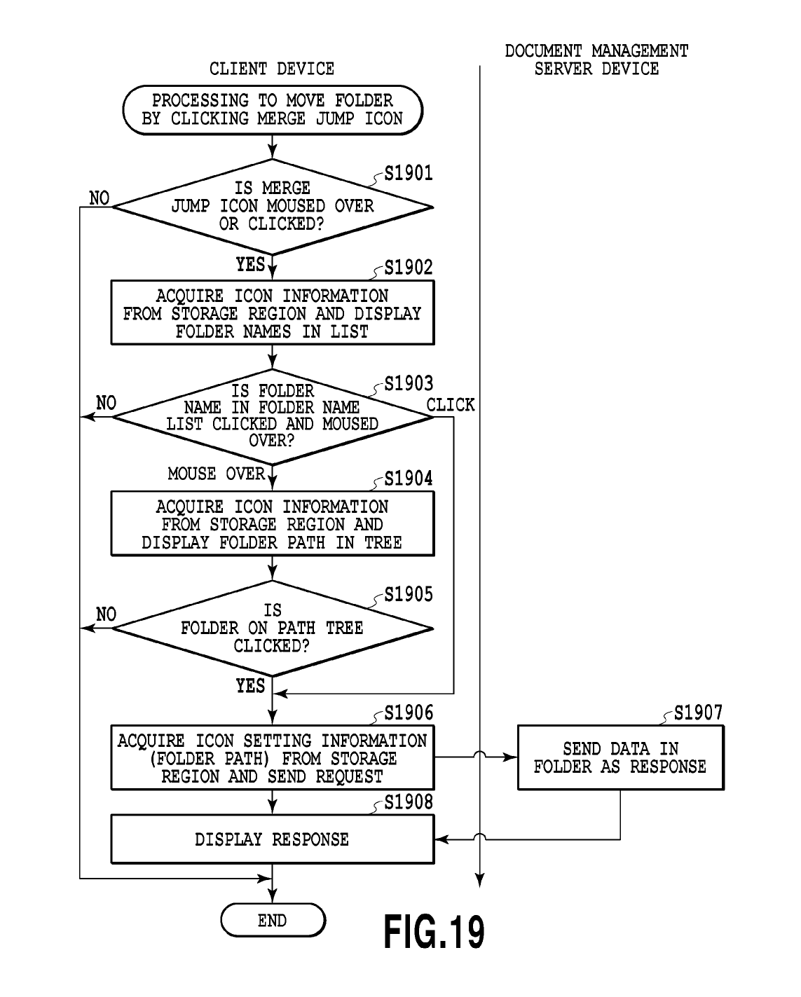

Next, Example 2 of the present invention is explained using FIG. 17, FIG. 18, and FIG. 19. In the present example, in the case where a plurality of jump icons exists in a fixed range (within a narrow range) on the scroll bar lane, a merge jump icon merging the plurality of icons into one is displayed.

### [Explanation of Merge Jump Icon]

FIG. 17 shows the way of display processing in the case where a user mouses over a merge jump icon.

In FIG. 17, with a merge jump icon 1701, the folders A121, B11 and B12 relating to the path tree are associated. In the case where a user mouses over the jump icon 1701, a tool tip 1702 that displays the names of the folders associated with the merge jump icon 1701 in the form of a list is displayed. In the example in FIG. 17, in the tool tip 1702, the folders A121, B11, and B12 are displayed in the form of a one-column list.

For example, in the case where a user clicks one of the folders displayed in a list in the tool tip 1702, data etc. associated with the clicked folder, for example, a lower-level folder(s) or document(s), is displayed in the document display region 602.

Alternatively, in the case where a user mouses over one of the folders displayed in a list in the tool tip 1702, the path of the folder is displayed as a tool tip 1703. For example, in the case where a user mouses over the folder A121 in the tool tip 1702, the path relating to the folder A121 is displayed in the tool tip 1703.

Here, with each folder 1704 relating to the path displayed in the tool tip 1703, a link is associated. Consequently, for example, in FIG. 17, in the case where a user clicks the folder A12 of each folder 1704, data etc. related to the folder A12 is displayed in the document display region 602.

Hereinafter, procedures of various kinds of processing relating to the merge jump icon in the present example are explained.

### <Jump Icon Merge Processing>

FIG. 18 is a flowchart showing a flow of processing (processing to merge icon representations) to merge a plurality of icons displayed on the scroll bar lane into a merge jump icon in the case where a plurality of jump icons exists in a fixed range on the scroll bar lane.

First, at step S1801, the display contents processing control unit 501 determines whether the jump icon is set to a folder. In the case where it is determined that the jump icon has been set (YES at S1801), the procedure proceeds to step S1802. On the other hand, in the case where it is determined that the jump icon has not been set, this processing is exited.

At S1802, the display contents processing control unit 501 acquires the icon setting information of the folder to which the jump icon is set.

Next, at step S1803, the display contents processing control unit 501 determines whether a plurality of jump icons displayed on the scroll bar lane exists in a fixed range based on the acquired icon setting information. In the case where it is determined that a plurality of jump icons displayed on the scroll bar lane exists in a fixed range (YES at S1803), the procedure proceeds to step S1804. On the other hand, in the case where it is determined that a plurality of jump icons displayed on the scroll bar lane does not exist in a fixed range, this processing is exited.

At step 1804, the display contents processing control unit 501 performs processing to merge jump icons. Specifically, the display contents processing control unit 501 generates one merge jump icon merging the plurality of jump icons.

### <Folder Contents Display Processing by Clicking Merge Jump Icon>

FIG. 19 is a flowchart showing a procedure of processing to display folder contents in accordance with a user's manipulation on the merge jump icon.

First, at step S1901, the display contents processing control unit 501 determines whether a user has moused over or performed the click operation on the merge jump icon. In the case where it is determined that the user has moused over or performed the click operation on the merge jump icon (YES at S1901), the procedure proceeds to step S1902. On the other hand, in the case where it is determined that the user has not moused over or performed the click operation on the merge jump icon, this processing is exited.

Next, at step S1902, the display contents processing control unit 501 acquires icon setting information. Then, the display contents processing control unit 501 causes the LCD 406 to display a tool tip in which each folder to which the merge jump icon is set is displayed in a list.

Next, at step S1903, the display contents processing control unit 501 determines whether a manipulation has been performed on the folder displayed on the tool tip and in the case where the manipulation is performed, and further determines whether the performed manipulation is mousing over or clicking. In the case where no manipulation is performed on the folder displayed on the tool tip, this processing is exited. In the case where the manipulation is performed on the folder displayed on the tool tip and the manipulation is mousing over, the procedure proceeds to step S1904. In the case where the manipulation is performed on the folder displayed on the tool tip and the manipulation is clicking, the procedure proceeds to step S1906.

At step S1904, the display contents processing control unit 501 acquires icon setting information and causes the LCD 406 to display the tool tip in which the path relating to the folder that is moused over is displayed in a tree form.

At step S1905, the display contents processing control unit 501 determines whether a folder on the tree of the path has been clicked. In the case where it is determined that a specific folder on the tool tip has been clicked by a user (YES at S1905), the procedure proceeds to step S1906. On the other hand, in the case where it is determined that no specific folder on the tool tip has been clicked by a user, this processing is exited.

At step S1906, the display contents processing control unit 501 acquires icon setting information and sends a request to the document management server device 101.

At step S1907, the display contents processing control unit 301 acquires folder information from the storage unit 302 and sends a response to the client device 102.

At step S1908, the display contents processing control unit 501 displays data etc. relating to a specific folder that is clicked on the LCD 406 based on the response from the document management server device.

According to the Example 2, in the case where a plurality of folders to which the jump icon is set aggregates densely, a merge jump icon that merges a plurality of jump icons is displayed, and therefore, it is made possible to produce an easier-to-see display.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-158701, filed Jul. 17, 2012, which is hereby incorporated by reference herein in its entirety.

What is claimed is:

1. A display control device comprising:
a tree display unit configured to display folders managed hierarchically in a storage device in a tree structure;
a reception unit configured to receive a specification of a folder to be displayed as a jump icon from a user; and
a display control unit configured to display a jump icon corresponding to the specified folder on a scroll bar lane.

2. The display control device according to claim 1, wherein
in a case where the jump icon is selected by a user, the display control unit displays a folder associated with the selected jump icon and data included in the folder.

3. The display control device according to claim 1, wherein
in a case where a cursor is put on the jump icon by a user's operation, the display control unit displays a path from a folder at a top level in a hierarchy to a folder associated with the jump icon on which the cursor is put.

4. The display control device according to claim 3, wherein
in a case where a folder in the displayed path is selected by a user, the display control unit displays a folder associated with the selected folder and its data.

5. The display control device according to claim 3, wherein
in a case where a cursor is put on the jump icon by the user's operation, the display control unit displays, with a tool tip, a path from the folder at the top level in the hierarchy to a folder associated with the jump icon on which the cursor is put.

6. The display control device according to claim 1, wherein
in a case where the specified folder is not displayed in a folder tree display region in which the folders are displayed in a tree structure, the display control unit displays a jump icon relating to the folder on the scroll bar lane.

7. The display control device according to claim 6, wherein
in a case where a folder being displayed in the folder tree display region is the specified folder, the display control unit does not display a jump icon relating to the displayed folder on the scroll bar lane.

8. The display control device according to claim 1, wherein
in a case where a folder at a lower level in a hierarchy of a folder being displayed in the folder tree display region is the specified folder and is not displayed in the folder tree display region, and also a cursor is put on a scroll bar knob by a user's operation, the display control unit displays a path from the folder at the top level in the hierarchy to the folder at the lower level in the hierarchy.

9. The display control device according to claim 1, wherein
the display control unit performs control so as to display the jump icon on the scroll bar lane in the case where a cursor is on the scroll bar lane, and not to display the jump icon on the scroll bar lane in the case where the cursor is not on the scroll bar lane.

10. The display control device according to claim 1, wherein
in a case where a plurality of jump icons corresponding to the specified folder exists in a fixed range on the scroll bar lane, the display control unit displays a merge jump icon merging the specified plurality of jump icons on the scroll bar lane, and in a case where a cursor is put on the merge jump icon by a user's operation, the display control unit displays names of a plurality of folders corresponding to the merge jump icon in a list.

11. The display control device according to claim 10, wherein
a folder associated with a folder selected by a user from among the plurality of folders displayed in the list or its data is displayed.

12. The display control device according to claim 11, wherein
a path from a folder at a top level in a hierarchy relating to a folder on which a user puts a cursor from among the plurality of folders displayed in the list to the folder on which the cursor is put is displayed.

13. The display control device according to claim 1, wherein
the storage device is a storage device connected via a network.

14. A display control method comprising the steps of:
displaying folders managed hierarchically in a storage device in a tree structure;
receiving a specification of a folder to be displayed as a jump icon from a user; and
displaying a jump icon to display the specified folder on a scroll bar lane.

15. A program stored in a non-transitory computer readable storage medium for causing a computer to perform the display control method according to claim 14.
